(19) United States
(12) Patent Application Publication
(10) Pub. No.: US 2006/0164845 A1
(43) Pub. Date: Jul. 27, 2006

(54) Icicle style light storage system

(76) Inventor: William C. White, San Ramon, CA (US)

Correspondence Address: William C White, 3128 Riviera Way, San Ramon, CA, 94583, US

(21) Appl. No.: 11/046,482

(22) Filed: Jan. 27, 2005

(51) Int. Cl. F21V 19/00

(52) U.S. Cl. 362/382

(57) ABSTRACT

A tangle free holiday light storage system, for storing holiday string lights especially favoring “icicle” type lights that provides easy use, secure and convenient storage, and rapid readiness for reuse. The present invention generally comprises of a substrate material with a series of hooks along the length. The light string is placed under the hooks and the substrate is then rolled containing and isolating the lights from tangling. To prepare the lights for use simply unroll the substrate and the light string is tangle free and ready for use.

### FIELD OF THE INVENTION

The present invention relates to . . . a device for preparing light strings, such as icicle style Christmas lights, for tangle-free storage and easy re-use.

### BACKGROUND OF THE INVENTION

Decorative light strings especially icicle style lights no matter how carefully wound for storage tend to become tangled. The time spent un-tangling light strings can become be come very laborious and time consuming.

The goal of this invention is to virtually eliminate any tangling and provide a quick and easy storage system for decorative light strings.

To provide a solution to the tangling and storage problem, various devices for storing light strings have been suggested. These devices often involve a flat card or base around which the light string must be meticulously wound. Some devices use a drum type device to wind the light strings around. For example,

U.S. Pat. No. 4,917,323 to Wing discloses a Christmas tree light storage device consisting of one or more discs each with a plurality of radially oriented slots around the outside circumference thereof which disc or discs are concentrically mounted on a central cylinder wherein light sockets are mounted sequentially over the slots with the cable to and from the sockets passing through the slots and being wrapped around the central cylinder.

U.S. Pat. No. 5,064,067 to McAllister, et al. describes a Christmas light organizer provides a frame for the handling and storage of a string of Christmas lights. A generally rectangular, planar frame includes two opposing sides having a series of tooth-like projections extending outwardly from the frame which are longitudinally beveled, having an inner gap between projections at their base which is less than a least thickness of the electric cord and an outer gap at their ends which is greater than the greatest thickness of the electric cord, thereby allowing a Christmas light cord to be inserted and guided between the converging faces of adjacent projections until the cord is securely gripped therebetween.

U.S. Pat. No. 5,661,953 to Jolley describes a Christmas light wrapping apparatus comprising wrapping trays with indentations for keeping the light strings separated and a base with a crankshaft for turning the trays, thereby winding the Christmas light strings.

U.S. Pat. No. 5,816,407 to Daratony discloses a device comprising a box shaped carrier having a bottom surface, four side walls depending there from and an open top. An interior box dimensioned slightly smaller than the carrier is received therein. A plurality of removable attached tubular members vertically depend from the bottom surface some of which are received within the interior box and are arranged in two opposing parallel rows. Opposing pairs of the tubular members received within the interior box each are surrounded by continuous pieces of fabric which form parallel sidewalls. The area between the fabric walls and the interior box define a plurality of soft, flexible storage compartments for receiving fragile decorations. Christmas light strands may be wrapped around adjacent pairs of the tubular members disposed externally of the interior box to prevent the strands from being entangled. Each of the components attached to the carrier bottom surface may be removed as desired.

U.S. Pat. No. 5,941,388 to Spielberger discloses a Christmas light storage system having a container with a lid, a plurality of racks, and a tower. The tower attaches to the container to provide a stable base, and individual racks attach to the tower to allow a strand of lights stored on the rack to be removed. The racks may be oscillating or compartmentalized racks, with the oscillating racks holding at least one strand of lights on each of the two sides of the rack. When removing the lights from the oscillating rack, one end of a strand of lights is pulled and the rack osculates or rocks back and forth to release the lights. The compartmentalized racks include individual compartments for each light bulb on a strand of lights. The compartmentalized rack may be attached to the tower so that an end of a strand of lights may be pulled to remove the entire strand from the rack. Both the oscillating and the compartmentalized racks include means for securing and separating the racks when stored in the container.

U.S. Pat. No. 6,237,769 to Collom May 29, 2001 describes a device that comprises a base unit and an extensible sheath, each having a longitudinal axis, with the base unit inserted through the sheath in its compressed form so that their longitudinal axes are essentially aligned. The base unit additionally comprises a coupler capable of securely holding one end of the light string to be stored. In operation, one end of the light string is attached to the coupler so that the sheath may be extended to surround and protect the length of the light string

U.S. Pat. No. 6,431,489 to Rose describes a storage device for storing strings Christmas, holiday or other strings of lights when the strings of lights are not in use. The device has an end having slots therethrough through which one or more of the ends of the string of lights are placed. A cap is then utilized to hold the light string end in position while the string itself is wound around the exterior surface of the storage device.

U.S. Pat. No. 6,823,993 to Cruze describes a device that consists of a cylindrical receptacle with a locking lid featuring a handle and from which extrudes a cylindrical core. The strands of lights would be wound on to the core, which can be rotated when the handle on the lid is pushed downward and turned.

Each of these devices provides some means for storing light strings but they do allow the light strands especially the sub strands on “icicle” lights to touch each other and possibly tangle.

It is therefore an object of the invention to . . . virtually eliminate the possibility of tangling, protect against breakage during storage, and allow for rapid deployment of the light strings for reuse.

### SUMMARY OF THE INVENTION

The present invention provides a new and useful Method for the storing of Christmas light stings that virtually eliminates tangles especially when used with “icicle” lights.

The present invention generally comprises of a rolled substrate material with a length slightly longer then a string of miniature Christmas lights or “icicle lights” and a width wider then the longest “icicle” on a string of said lights. On this substrate there is a series of fold out hooks along the length of the substrate. The section if the main cable of the Icicle light string is placed behind one of the fold out hooks and the substrate is rolled to the next fold out hook and the process is repeated.

### BRIEF DESCRIPTION OF THE DRAWINGS

A complete understanding of the present invention may be obtained by reference to the accompanying drawings, when considered in conjunction with the subsequent, detailed description, in which:

For purposes of clarity and brevity, like elements and components will bear the same designations and numbering throughout the FIGURES.

### DESCRIPTION OF THE PREFERRED EMBODIMENT

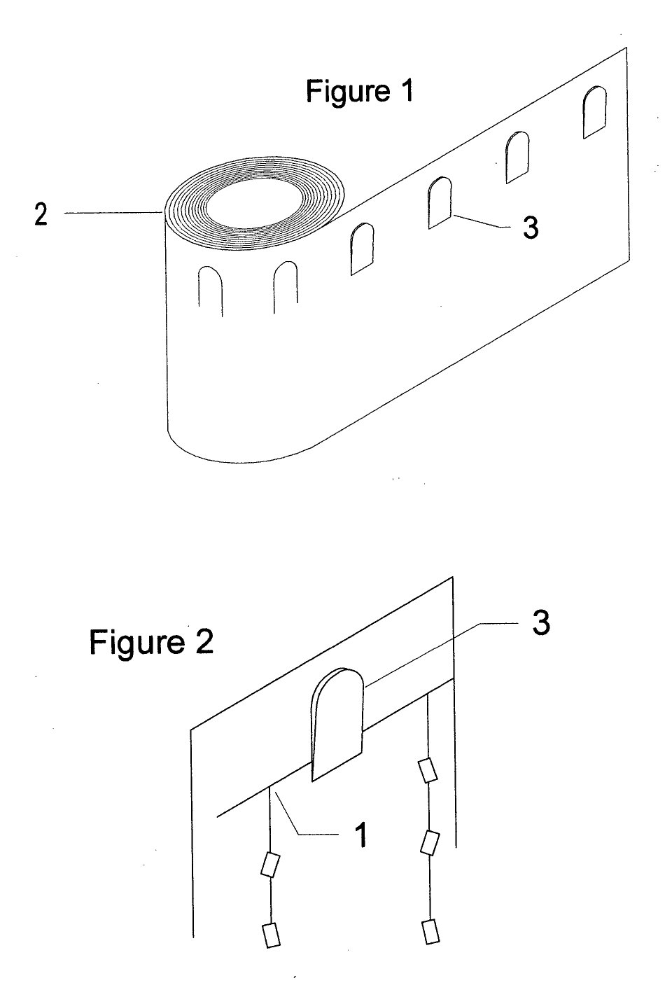

FIG. 1 is an isometric view of the roll of substrate material 2 illustrating fold out hook 3.

FIG. 2 is a enlarged view of substrate 2 clearly illustrating fold out hook 3 containing a section of “icicle light” 1.

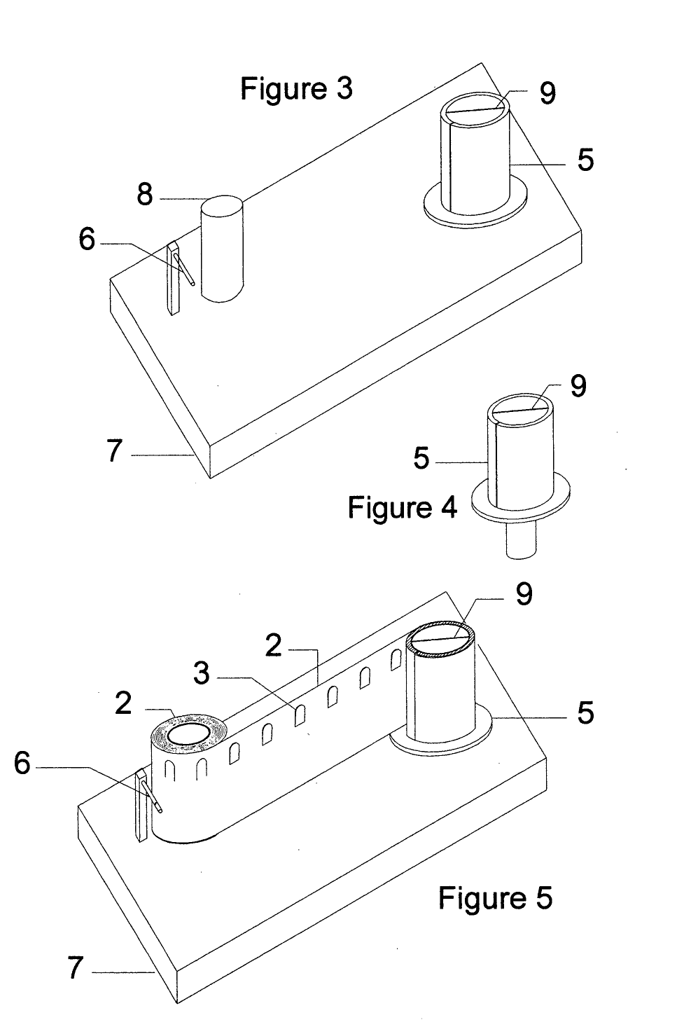

FIG. 3 is an isometric view of base assembly 7 illustrating the cable guide 6, substrate roll holder 8, and takeup spool 5 that has rotation grip 9 fastened to the top of the spool.

FIG. 4 illustrates the takeup spool 5 removed from the base.

FIG. 5 illustrates the base assembly 7 with the substrate roll 2 in place for use.

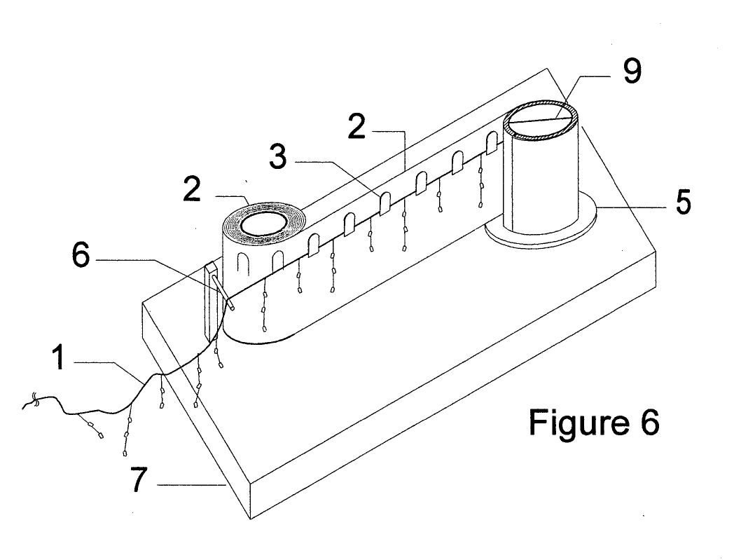

FIG. 6 illustrates the base assembly 7 with the substrate roll 2 in place and “icicle light” string 1 in position for winding.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An icicle style light storage system comprising:
means for the underlayment of a light string preventing contact with any other portion of the light string when rolled.;
means for the controled placement of the light string when placed on the substrate., rigidly connected to said means for the underlayment of a light string preventing contact with any other portion of the light string when rolled.; and
means for supporting the substrate roll holder, the light string cable guide, and the removeable substrate take up roll spool., removably connected to said means for the underlayment of a light string preventing contact with any other portion of the light string when rolled.

2. The icicle style light storage system in accordance with claim 1, wherein said means for the underpayment of a light string proventing contact with any other portion of the light string when rolled. comprises a substrate material.

3. The icicle style light storage system in accordance with claim 1, wherein said means for the controled placement of the light string when placed on the substrate. comprises a fold out hook.

4. The icicle style light storage system in accordance with claim 1, wherein said means for supporting the substrate roll holder, the light string cable guide, and the removeable substrate take up roll spool. comprises a base assembly.

5. An icicle style light storage system comprising:
a substrate material, for the underlayment of a light string preventing contact with any other portion of the light string when rolled.;
a fold out hook, for the controled placement of the light string when placed on the substrate., rigidly connected to said Substrate Material; and
a base assembly, for supporting the substrate roll holder, the light string cable guide, and the removeable substrate take up roll spool., removably connected to said Substrate Material.

6. An icicle style light storage system comprising:
a substrate material, for the underlayment of a light string preventing contact with any other portion of the light string when rolled.;
a fold out hook, for the controled placement of the light string when placed on the substrate., rigidly connected to said Substrate Material; and
a base assembly, for supporting the substrate roll holder, the light string cable guide, and the removeable substrate take up roll spool., removably connected to said Substrate Material.
